(19) United States
(12) Patent Application Publication
(10) Pub. No.: US 2013/0128931 A1
(43) Pub. Date: May 23, 2013

(54) ON-CHIP RADIO CALIBRATION

(71) Applicants: Chung-Chieh Lin, Fremont, CA (US); Shih Hsiung Mo, San Jose, CA (US); Yan Cui, Plano, TX (US); Chung-Hsing Chang, Milpitas, CA (US)

(72) Inventors: Chung-Chieh Lin, Fremont, CA (US); Shih Hsiung Mo, San Jose, CA (US); Yan Cui, Plano, TX (US); Chung-Hsing Chang, Milpitas, CA (US)

(73) Assignee: AVIACOMM INC., Santa Clara, CA (US)

(21) Appl. No.: 13/299,273

(22) Filed: Nov. 17, 2011

(51) Int. Cl. H04L 25/49; H04B 1/38

(52) U.S. Cl. 375/219; 375/296

(57) ABSTRACT

One embodiment of the present invention provides a quadrature-mixing transmitter for wireless communication. The transmitter includes a quadrature modulator comprising an in-phase (I) channel and a quadrature (Q) channel, a calibration-signal generator configured to generate calibration signals that are sent to the I channel and the Q channel, and a calibration circuit configured to calibrate an imbalance between the I channel and the Q channel. The modulator, the calibration-signal generator, and the calibration circuit are located on a same integrated circuit (IC) chip, thereby facilitating on-chip calibration of the imbalance between the I channel and the Q channel.

### BACKGROUND

1. Field

The present disclosure relates generally to a radio circuit used in wireless communication systems. More specifically, the present disclosure relates to a radio circuit enabled with on-chip calibration.

2. Related Art

Traditional wireless communication systems are usually designed for a specific standard, such as GSM (Global System for Mobile Communications) or Wideband Code Division Multiple Access (W-CDMA), each requiring different carrier frequencies. For example, the carrier frequency of the GSM signals varies from 800 MHz to 1 GHz, while the carrier frequency of the W-CDMA varies between 2-3 GHz. Current demand for convergence of wireless services, in which users can access different standards from the same wireless device, is driving the development of multi-standard and multi-band transceivers, which are capable of transmitting/receiving radio signals in the entire wireless communication spectrum (from 300 MHz to 3 GHz).

Many significant technical challenges are involved with the multi-standard/multi-band transceivers. For example, process variations may lead to a large deviation of resistor or capacitor values, which in turn results in a large deviation of bandwidth (often as large as 40%). In addition, DC offsets, In-phase/Quadrature (I/Q) amplitude and phase mismatch, and local oscillator (LO) carrier leakage are other problems facing a non-ideal transceiver.

### SUMMARY

One embodiment of the present invention provides a quadrature-mixing transmitter for wireless communication. The transmitter includes a quadrature modulator comprising an in-phase (I) channel and a quadrature (Q) channel, a calibration-signal generator configured to generate calibration signals that are sent to the I channel and the Q channel, and a calibration circuit configured to calibrate an imbalance between the I channel and the Q channel. The modulator, the calibration-signal generator, and the calibration circuit are located on a same integrated circuit (IC) chip, thereby facilitating on-chip calibration of the imbalance between the I channel and the Q channel.

In a variation on this embodiment, the calibration-signal generator includes one or more digital-to-analog converters (DACs).

In a variation on this embodiment, the calibration signals include a pair of conjugate DC signals.

In a variation on this embodiment, the calibration circuit includes a power detector configured to receive an output of the quadrature modulator, in response to the calibration signals.

In a variation on this embodiment, the calibration circuit includes a control module configured to control paths of the I channel and the Q channel based on outputs of the power detector.

In a variation on this embodiment, the imbalance includes a phase imbalance and an amplitude imbalance.

In a variation on this embodiment, the calibration circuit is further configured to calibrate a DC offset.

### BRIEF DESCRIPTION OF THE FIGURES

FIG. 1 presents a diagram illustrating the architecture of a direct-conversion receiver.

FIG. 2 presents a schematic of a quadrature-mixing transmitter with on-chip calibration, in accordance with an embodiment of the present invention.

FIG. 3 presents a schematic of a quadrature-mixing transceiver with on-chip calibration, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide a solution for on-chip I/Q imbalance and carrier leakage calibration. Instead of relying on an external test-tone, an on-chip digital-to-analog converter (DAC) generates a simple quadrature signal which can be fed into a calibration loop in order to minimize carrier leakage as well as I/Q imbalance.

### On-Chip Calibration

Modern radio transmitters/receivers often employ quadrature-mixing front-ends. The quadrature-mixing front-end architecture allows low-cost, low-power, monolithic implementations, while providing theoretically infinite image rejection ratios. Note that the image rejection quality eliminates the need for many off-chip components. However, there are challenges in realizing ideal quadrature-mixing front-ends because gain and phase mismatches between the I and Q channels, as well as carrier leakage can significantly degrade the image rejection ratio.

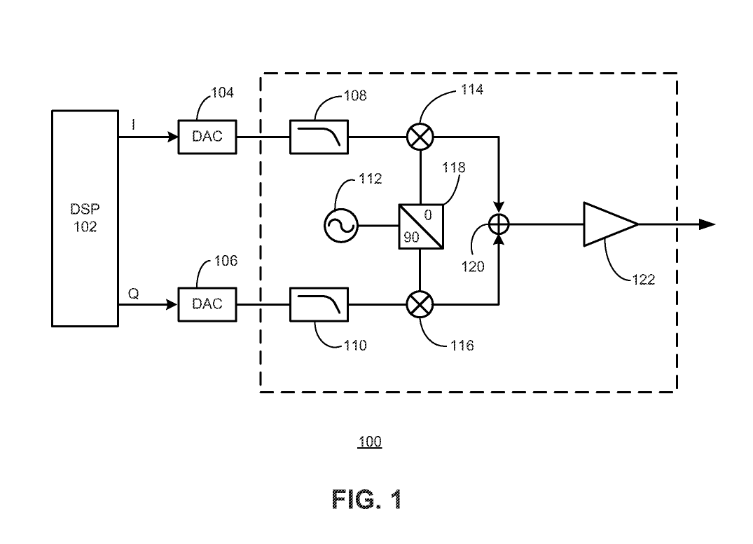

FIG. 1 presents a diagram illustrating the architecture of a quadrature-mixing transmitter. Transmitter 100 includes a baseband digital signal processor (DSP) 102 and 104, digital-to-analog converters (DACs) 104 and 106, low-pass filters (LPFs) 108 and 110, a local oscillator 112, mixers 114 and 116, a phase shifter 118, an adder 120, and an amplifier 122.

During operation, baseband DSP 102 and 104 generate baseband signals for I and Q channels. The I and Q baseband signals are first converted to analog domain by DACs 104 and 106, and then are filtered by LPFs 108 and 110, respectively. The filtered signals are sent to mixers 114 and 116 to be mixed with the output of local oscillator 112. Note that phase shifter 118 introduces a 90° phase shift between the I and Q channels. The I and Q signals are then added by adder 120, and the summation signal is amplified by amplifier 122. Note that a typical transmitter integrated circuit (IC) chip includes LPFs 108 and 110, LO 112, mixers 114 and 116, phase shifter 118, adder 120, and amplifier 122, as shown by the box in dashed lines.

When the I/Q mismatch (including phase and amplitude), non-zero DC offsets in the I and Q signal paths, and the carrier leakage are considered, the transmitter output can be expressed as:

$$s ( t ) = [ {D}_{I} + {m}_{I} ( t ) ] g cos ( ω t + \frac{φ}{2} ) + [ {D}_{Q} + {m}_{Q} ( t ) ] sin ( ω t - \frac{φ}{2} ) + α cos ( ω t + γ ) ,$$

where m_{I}(t) and m_{Q}(t) are transmitted baseband signals for the I and Q channels, g is the gain imbalance between the I and Q channels, φ defines how much the difference in phase between the LO inputs to the I and Q channels deviates from 90°, D_{I} and D_{Q} are DC-offsets in the I and Q signal paths, and α cos(ωt+γ) is the carrier leakage with unknown amplitude a and unknown phase γ.

The baseband or low-pass equivalent of the transmitter output can be expressed as:

\tilde{s}(t)=m(t)V₁+m*(t)V₂*+(DV₁+D*V₂*+αe^{jγ}),

where m(t)=m_{I}(t)+jm_{Q}(t) is the transmitted baseband signal, D=D_{I}+jD_{Q} is the DC offset, and V₁ and V₂ are related to the amplitudes of the oscillator signals (one is the desired frequency and one is the image frequency) and are defined as:

$${V}_{1} = cos ( \frac{φ}{2} ) ( \frac{g + 1}{2} ) + j sin ( \frac{φ}{2} ) ( \frac{g - 1}{2} ) and$$

$${V}_{2} = cos ( \frac{φ}{2} ) ( \frac{g - 1}{2} ) - j sin ( \frac{φ}{2} ) ( \frac{g + 1}{2} ) .$$

Note that the first term of the baseband equivalent of the transmitter output is the desired signal, the second term is the image signal, and the third term is the DC offset. Compensating for the I/Q imbalance and DC offsets means minimizing the second and third terms.

Various techniques have been proposed to calibrate (or compensate for) the I/Q imbalance, DC offsets, and the carrier leakage. A conventional calibration method relies on the baseband DSP to provide a test-tone (or pilot) signal for its calibration loop. However, such configurations require involvements from off-chip components (such as the baseband DSP). A certain class of communication standards includes known pilots in the received signals, which can be used for calibration. However, in a practical scenario, the pilots are likely to be affected by other impairments, such as the transmission channel, making an accurate pilot-based I/Q imbalance compensation a challenge. To solve this problem, embodiments of the present invention provide a solution for on-chip calibration. In one embodiment, the generation of the calibration signals does not involve any off-chip component, such as the baseband DSP. In a further embodiment, the calibration signals are two conjugate signals.

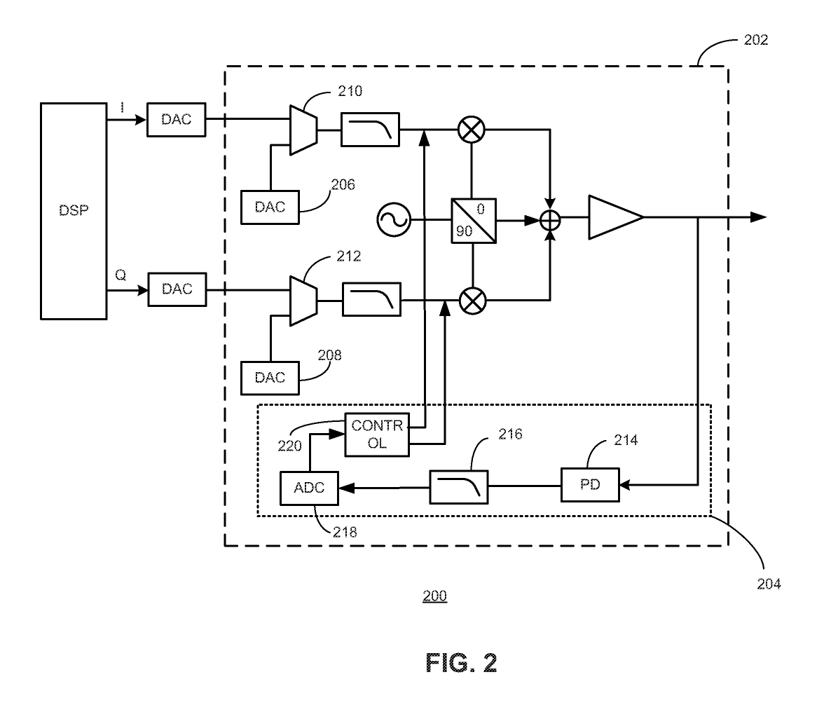

FIG. 2 presents a schematic of a quadrature-mixing transmitter with on-chip calibration, in accordance with an embodiment of the present invention. The structure of quadrature-mixing transmitter 200 is similar to that of quadrature-mixing transmitter 100, except that transmitter IC chip 202 now includes a calibration loop 204, which includes a power detector 214, an LPF 216, an analog-to-digital converter (ADC) 218, and a control module 220. In addition, at the I and Q inputs of transmitter IC chip 202, outputs from on-chip DACs 206 and 208 are multiplexed with the I and Q signals via multiplexers 210 and 212, respectively.

During the calibration interval, the I and Q channel inputs to transmitter IC chip 202 are set as zero, and an on-chip calibration signal is generated by DACs 206 and 208. The calibration signal is quadrature modulated and then detected by an envelope detector, such as PD 214. The detected output is filtered by LPF 216 and converted to the digital domain by ADC 218. Output of ADC 218 is sent to control module 220, which in turn controls the I and Q paths based on the ADC output in order to compensate for the I/Q imbalance and the DC offset. In a further embodiment, control module 220 is configured to compensate for the phase and amplitude of the I/Q imbalance as well as the DC offset.

Note that in order to compensate the I/Q imbalance and the DC offset, calibration loop 204 needs to estimate the amount of the I/Q imbalance and the DC offset. A carefully selected calibration signal can facilitate such estimation. Note that various formats of calibration signals are possible. In the conventional solution where an external test-tone signal is used, the test-tone is usually a sinusoidal signal. Generating an on-chip sinusoidal test signal often requires complex circuitry. For the integrated solution, it is desirable to have a simpler circuit design. In some embodiments, simple DACs that are capable of generating DC signals are used to generate the calibration signals. In a further embodiment, a pair of conjugate signals (κ and κ*) are used as the calibration signal, wherein κ=κ_{I}+jκ_{Q}. By comparing the outputs of ADC 218 in response to the pair of conjugate signals, control module 220 can obtain an estimation of the I/Q imbalance and the DC offset, and thus is able to make adjustments to the I and Q paths in order to compensate for the I/Q imbalance (including phase and amplitude) and the DC offset. Note that by manipulating (such as adding and subtracting) the outputs of ADC 218 in response to the conjugate signals, (κ_{I},κ_{Q}) and (κ_{I},−κ_{Q}), one can extract information associated with the I/Q imbalance and the DC offset.

Note that if the IC chip is a transceiver chip, which includes both a transmitter portion and a receiver portion, then the transmitter output can be fed back to the input of the receiver for calibration purposes. In other words, the transmitter outputs in response to the calibration signals (generated by the on-chip DACs) are fed back to the receiver circuitry, and a control module is configured to adjust the phase and amplitude for the I and Q paths based on the digital output of the receiver circuitry.

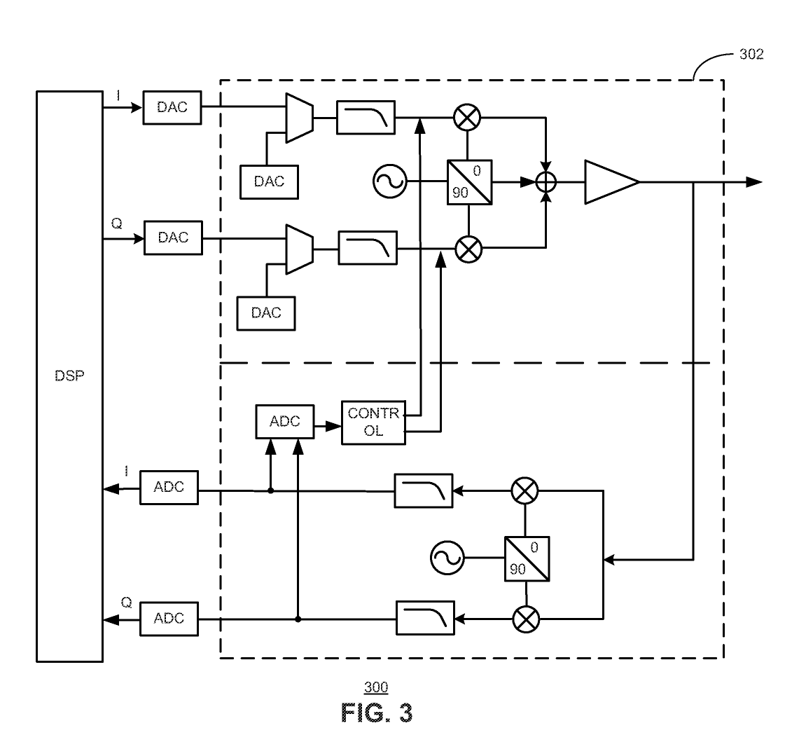

FIG. 3 presents a schematic of a quadrature-mixing transceiver with on-chip calibration, in accordance with an embodiment of the present invention. Transceiver 300 includes a transceiver IC chip 302. The top part of transceiver IC chip 302 includes circuitry for the transmitter, and the bottom part of transceiver IC chip 302 includes circuitry for the receiver. Transceiver chip 302 can be fabricated using a standard complementary metal-oxide-semiconductor (CMOS) technology.

The circuits shown in FIGS. 2 and 3 are merely exemplary and should not limit the scope of this disclosure. In general, embodiments of the present invention provide a solution that enables on-chip calibration for I/Q imbalance and DC offset. Other circuit configurations are also possible.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A quadrature-mixing transmitter for wireless communication, comprising:
a quadrature modulator comprising an in-phase (I) channel and a quadrature (Q) channel;
a calibration-signal generator configured to generate calibration signals that are sent to the I channel and the Q channel; and
a calibration circuit configured to calibrate an imbalance between the I channel and the Q channel, wherein the modulator, the calibration-signal generator, and the calibration circuit are located on a same integrated circuit (IC) chip, thereby facilitating on-chip calibration of the imbalance between the I channel and the Q channel.

2. The transmitter of claim 1, wherein the calibration-signal generator includes one or more digital-to-analog converters (DACs).

3. The transmitter of claim 1, wherein the calibration signals include a pair of conjugate DC signals.

4. The transmitter of claim 1, wherein the calibration circuit includes a power detector configured to receive an output of the quadrature modulator, in response to the calibration signals.

5. The transmitter of claim 1, wherein the calibration circuit includes a control module configured to control paths of the I channel and the Q channel based on outputs of the power detector.

6. The transmitter of claim 1, wherein the imbalance includes a phase imbalance and an amplitude imbalance.

7. The transmitter of claim 1, wherein the calibration circuit is further configured to calibrate a DC offset.

8. A quadrature-mixing transceiver for wireless communication, comprising:
a transmitter, wherein the transmitter includes a quadrature modulator comprising an in-phase (I) channel and a quadrature (Q) channel;
a calibration-signal generator configured to generate calibration signals that are sent to the I channel and the Q channel;
a receiver; and
a calibration control module coupled to the receiver, wherein the control module is configured to calibrate an imbalance between the I channel and the Q channel, wherein the transmitter, the calibration-signal generator, the receiver, and the calibration control module are located on a same integrated circuit (IC) chip, thereby facilitating on-chip calibration of the imbalance between the I channel and the Q channel.

9. The transceiver of claim 8, wherein the calibration-signal generator includes one or more digital-to-analog converters (DACs).

10. The transceiver of claim 8, wherein the calibration signals include a pair of conjugate DC signals.

11. The transceiver of claim 8, wherein the receiver is configured to receive outputs of the quadrature modulator in response to the calibration signals, and wherein the control module is configured to control paths of the I channel and the Q channel based on the received outputs.

12. The transceiver of claim 8, wherein the imbalance includes a phase imbalance and an amplitude imbalance.

13. The transceiver of claim 8, wherein the calibration control module is further configured to calibrate a DC offset.

14. A method for calibrating an imbalance between an I channel and a Q channel of a quadrature modulator, comprising:
generating, by a calibration-signal generator, calibrations signals, wherein the calibration signals include a pair of conjugate DC signals;
inputting the calibration signals to the quadrature modulator;
detecting outputs of the quadrature modulator in response to the calibration signals; and
calibrating the imbalance between the I channel and the Q channel based on the detected outputs.

15. The method of claim 14, wherein the calibration signal generator includes one or more digital-to-analog converters (DACs).

16. The method of claim 14, wherein the calibration signal generator and the quadrature modulator are located on a same integrated circuit (IC) chip, thereby facilitating on-chip calibration of the imbalance between the I channel and the Q channel.

17. The method of claim 14, wherein the imbalance includes a phase imbalance and an amplitude imbalance.

18. The method of claim 14, wherein the method further comprises calibrating a DC offset.
